(19) United States
(12) Patent Application Publication
(10) Pub. No.: US 2006/0098342 A1
(43) Pub. Date: May 11, 2006

(54) Magnetic disk cartridge

(75) Inventors: Ayako Matsumoto, Odawara-shi (JP); Shinji Saito, Odawara-shi (JP); Hitoshi Noguchi, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/221,731

(22) Filed: Sep. 9, 2005

(30) Foreign Application Priority Data
Sep. 9, 2004 (JP) 261748/2004

(51) Int. Cl. G11B 23/03

(52) U.S. Cl. 360/133

(57) ABSTRACT

A magnetic disk cartridge, which holds therein a magnetic disk with recording density and has a liner composed of polyethylene terephthalate fibers, is provided which achieves a good dust-removal effect by the liner without flawing the magnetic disk and without increasing the rotary torque of the magnetic disk. A magnetic layer of the magnetic disk is formed such that the magnetic layer contains diamond particles which have an average particle size satisfying a relationship “b−0.05≦a≦b+0.1” at 1% to 10% by weight with respect to the ferromagnetic material, where “a” represents the average particle size of the diamond particles in units of μm and “b” represents a thickness of the magnetic layer in units of μm. The fibers of the liner are selected from the fibers whose fiber diameter varies in its length direction.

### BACKGROUND OF THE PRESENT INVENTION

1. Field of the Present Invention

The present invention relates to a magnetic disk cartridge having a casing which holds therein a discoid magnetic disk, and more particularly to a magnetic disk cartridge having a liner which is provided within the casing and serves to remove contaminants on a surface of the magnetic disk.

2. Description of the Related Art

Conventionally, there have been provided magnetic disk cartridges which rotatably hold in its casing a flexible magnetic disk which comprises a flexible discoid substrate formed of a material such as a polyester sheet, and magnetic layers disposed on opposite sides of the substrate. For the advantages of the magnetic disk cartridges of this type such that, they are easily handled and low in cost, the magnetic disk cartridges have been mainly used as recording media for computers.

In the aforementioned disk cartridge, any dust and foreign matter adhering to the magnetic disk may cause a quality defect, so-called “dropout”. The higher the recording density of the magnetic disks, the more the dropout problem tends to occur easily.

Accordingly, for the purpose of removing the dust and foreign matter on the magnetic disk and keeping the surface of the magnetic disk clean, a structure in which a liner is affixed on each inner surface of the cartridge on the side facing or opposite the information recording medium has been widely used in the conventional disk cartridges. The aforementioned liner is formed of a material whose surface to be applied to the magnetic disk is napped. Specifically, the napped surface of the liner is brought into contact with the rotating magnetic disk, so that the dust and/or foreign matter deposited on the magnetic disk can be wiped off and captured thereby.

It has been known that when, for example, polyethylene terephthalate is used as a material of the liner as described above, a good dust-removal effect can be achieved. See, for example, U.S. Patent Application Publication No. 20040096702.

Using polyethylene terephthalate as a material of the liner, however, causes problems of abrasion of the surface of the magnetic disk and increase of rotary torque of the magnetic disk.

In recent years, there has been demand for smaller magnetic disks with a higher storage capacity. Accordingly, needs have arisen for higher recording density and narrower data tracks. In the magnetic disks with a higher recording density as described above, even minute dust particles which have been substantially negligible heretofore may cause fatal errors when attached on the, magnetic disk. Further, production of slight flaws on the surface of the magnetic disk may also cause fatal errors. Thus, there is a need for magnetic disk cartridges which can provide a good dust-removal effect without flawing the magnetic disk and without increasing the rotary torque of the magnetic disk.

### SUMMARY OF THE PRESENT INVENTION

Accordingly, in view of the foregoing drawbacks, an object of the present invention is to provide a magnetic disk cartridge, holding therein a magnetic disk with a higher recoding density, which provides a good dust removal effect without flawing the magnetic disk and without increasing a rotary torque of the magnetic disk.

A magnetic disk cartridge according to the present invention comprises; a magnetic disk comprising a discoid nonmagnetic substrate and a magnetic layer that is formed of a ferromagnetic material and layered on at least one surface of the nonmagnetic substrate, the magnetic disk having a surface recording density of at least 158.7 Mbit/cm2; a casing which rotatably holds therein the magnetic disk; and a liner, which is composed of polyethylene terephthalate fibers and attached to a surface of the casing that faces the magnetic disk, for removing contaminants on the surface of the magnetic disk, wherein the magnetic layer contains diamond particles which have an average particle size satisfying a formula given by b−0.05≦a≦b+0.1 at 1% to 10% by weight with respect to the ferromagnetic material, where “a” represents the average particle size of the diamond particles in units of μm and “b” represents a thickness of the magnetic layer in units of μm, and wherein a fiber diameter of the fibers of the liner varies along a length direction of the fibers.

Further, the minimum fiber diameter of the fibers of the liner is preferably Within the range of 5% to 60% of the maximum fiber diameter of the fibers

Further, it is preferable that the ferromagnetic material is hexagonal ferrite powder.

As used herein, the expression “a fiber diameter of the fibers of the liner varies along a length direction of the fibers” means that a fiber diameter varies depending on a position along the length direction of the fiber, that is, a single fiber has a plurality of fiber diameters.

In a magnetic disk cartridge of the present invention, a magnetic layer is formed which contains diamond particles which have an average particle size satisfying a formula given by b−0.05≦a≦b+0.1 at 1% to 10% by weight with respect to the ferromagnetic material. The diamond particles have an average particle size satisfying the following formula:
b−0.05≦a≦b+0.1 (Formula 1)
where “a” represents an average particle size of the diamond particles in units of μm and “b” represents a thickness of the magnetic layer in units of μm, and the fibers of the liner are selected from those having a fiber diameter which varies along a length direction of the fibers. Therefore, a good dust-removal effect can be achieved without flawing the magnetic disk and without increasing the rotary torque of the magnetic disk.

Further, in the aforementioned magnetic disk cartridge, when fibers of the liner are selected from among those having the minimum fiber diameter which falls within the range of 5% to 60% of its maximum fiber diameter, a better dust-removal effect can be achieved.

Further, in the aforementioned magnetic disk cartridge, when hexagonal ferrite powder is used as the ferromagnetic material, a higher surface recording density of the magnetic disk can be achieved, whereby the aforementioned effect is even more pronounced.

### BRIEF DESCRIPTION OF THE DRAWINGS

FIG. 1 is an exploded perspective view showing a magnetic disk cartridge according to an embodiment of the present invention;

FIG. 2 is an enlarged view of a fiber forming a liner of the magnetic disk cartridge of the present invention; and

FIG. 3 is a view for illustrating a method of evaluating an increase of rotary torque of the magnetic disk cartridge of the present invention.

### DESCRIPTION OF THE PREFERRED EMBODIMENTS

Hereinafter, a magnetic disk cartridge of the present invention will be described in detail in terms of preferred embodiments with reference to the drawings. The magnetic disk cartridge of the present invention is particularly characterized by a material and thickness of a magnetic layer of the magnetic disk and a material of a liner. First, a description will be given on the general structure of the magnetic disk cartridge.

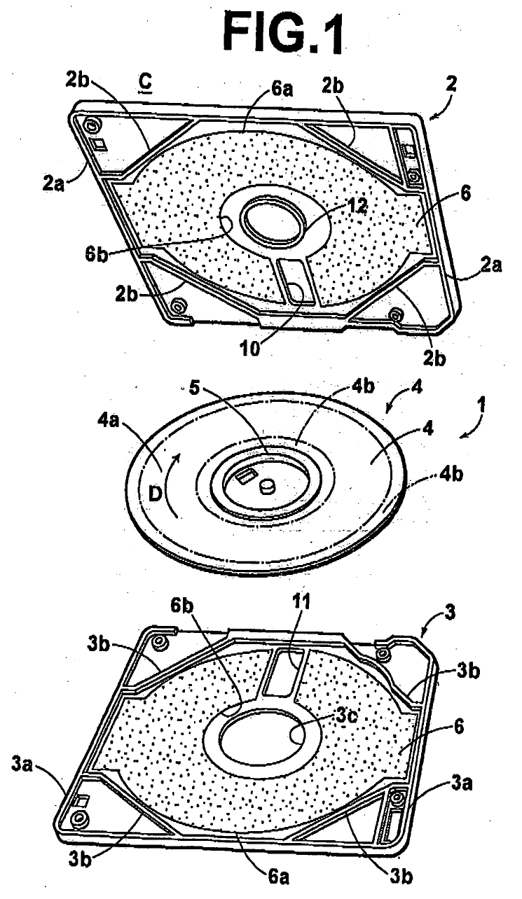

FIG. 1 is an exploded perspective view showing a magnetic disk cartridge according to the embodiment of the present invention. The magnetic disk cartridge 1 shown in FIG. 1 is a disk cartridge for so-called 3.5 inch type floppy disks. The magnetic disk cartridge comprises a casing C formed by joining an upper shell 2 and a lower shell 3; a discoid magnetic disk 4 rotatably housed in the casing C; and a pair of dust-removing liners 6 arranged to face both sides of the magnetic disk 4 within the casing C.

The upper shell 2 and lower shell 3 are flat and substantially rectangular in shape, and formed of synthetic resin such as acrylonitrile-butadiene-styrene copolymer. The perimeters of the upper and lower shells 2 and 3 are provided with outer ribs 2a and 3a constituting side walls, and the corners are provided with oblique reinforcement inner ribs 2b and 3b. The upper and lower shells 2 and 3 further have elongate slots 10 and 11 through which magnetic heads can access the magnetic disk 4.

A circular spindle aperture 3c, of the same size as a center core 5, is formed at the central portion of the lower shell 3. An annular protrusion 12, which is located inside an annular portion at the outer, periphery of the center core 5, is provided at the central portion of the inner surface of the upper shell 2. The annular protrusion 12 is designed to engage with the interior of the annular portion of the center core 5, thereby restricting movement of the magnetic disk 4 in its radial direction.

The magnetic disk 4 is, for example, a magnetic disk which comprises a flexible discoid base, for example, formed of a polyester sheet or the like; and magnetic layers layered on opposite sides of the base, and which is held at its central portion by the center core 5. When the disk cartridge 1 is loaded into a drive device (not shown), the center core 5 engages with a rotating spindle of the drive device so as to rotatably hold the magnetic disk 4.

Liners 6, each of which faces the magnetic disk 4, are attached to the interior surfaces of the upper shell 2 and the lower shell 3 by heat welding, adhesive or the like. These liners are of the same shape as each other (they are symmetrical). Portions that overlap with the windows 10, 11 are cut out, and circular apertures, each of which are larger than the outer diameter of either the annular protrusion 12 or the spindle aperture 3c, are formed at the central portions as well.

Next, the magnetic disk 4 and liners 6 will be described below in detail.

In the magnetic disk 4, a recording region 4a is provided on the magnetic disk 4 at an annular region excluding its outermost region and innermost region. The recording region 4a contains a non-recording region 4b along its outer peripheral edge. The recording region 4a of the magnetic disk is designed to have a surface recording density of about 158.7 Mbit/cm² (1 Gbit/inch²) or more. Preferably, the magnetic disk 4 has a surface recording density of 793.5 Mbit/cm² (5 Gbit/inch²) or more. Data is reproduced from and recorded on the magnetic disk 4 by an MR head (not shown) of a disk drive. Using the MR head enables achievement of low noise and a high S/N ratio. Further, a head used for reproducing data on the magnetic disk 4 is not limited to an MR head, and a GMR head, a TMR head etc. can be used.

The magnetic disk 4 comprises a substrate; a lower layer which is formed on the substrate and substantially nonmagnetic; and a magnetic layer which is formed on the lower layer and composed of a binder and ferromagnetic hexagonal ferrite powder dispersed in the binder. Hereinafter the constitutional elements of the magnetic disk 4 in the present invention will be described in further detail.

[Magnetic Layer]

First, a description will be given on the magnetic layer formed on the magnetic disk 4. The magnetic disk 4 according to the embodiment is generally provided with a magnetic layer on both sides of a discoid substrate as mentioned above, but may be provided on one side only of the substrate. The magnetic layer may comprise a single layer or a plurality of layers each having a different composition. Further, it is preferable to provide a substantially nonmagnetic lower layer (also referred to as “a nonmagnetic layer” or “a lower layer”) between the substrate and the magnetic layer using techniques such as wet-on-wet and wet-on-dry techniques. The magnetic layer is referred to as an upper layer or an upper magnetic layer.

Ferromagnetic powders for use in the magnetic layer are not particularly restricted, but ferromagnetic metal powder and hexagonal ferrite powder are preferably used, and hexagonal ferrite powder is especially preferred.

Such ferromagnetic metal powders are not particularly limited so long as they contain α-Fe as a main component (including alloys). The ferromagnetic powders may contain, in addition to the prescribed atoms, Al, Si, S, Ca, Ti, V, Cr, Cu, Y, Mo, Rh, Pd, Ag, Sn, Ba, Ta, W, Au, Bi, La, Ce, Pr, Nd, P, Co, Mn, Zn, Ni, Sr and B, for example. Ferromagnetic powders containing at least one of Al, Si, Ca, Y, Ba, La, Nd, Co, Ni and B in addition to α-Fe is preferred, and that containing Co, Al, Y and Nd is particularly preferred. More specifically, ferromagnetic powders containing from 10 to 50 atomic % of Co; from 2 to 20 atomic % of Al; and from 3 to 20 atomic % of Y and/or Nd, respectively based on Fe, is preferred.

To bring out the maximum performance characteristics in a high density region, ferromagnetic metal powders excellent in high output, high dispersibility and orientation are used in the present invention. That is, high output and high durability can be attained with ferromagnetic metal powders comprising hyper-fine particles, particularly having an average long axis length of from 30 to 65 nm, having a crystallite size of from 80 to 140 Å, containing a great amount of Co, and containing Al and Y compounds as sintering inhibitors. In addition, it is also necessary that these ferromagnetic metal powders be excellent in particle size distribution, such that they preferably have a variation coefficient of long axis length (standard deviation of long axis length/average long axis length) of from 0 to 30%, an average acicular ratio of from 3.5 to 7.5, a coercive force of from 143 to 223 kA/m, a saturation magnetization of from 85 to 125 A·m²/kg, and a specific surface area by a BET method (S_{BET}) Of from 45 to 120 m²/g. These powders can be obtained according to methods known in the art. To achieve high density recording, the coercive force of the ferromagnetic powders is preferably high, e.g., from 143 to 223 kA/m, although it is dependent upon the performance of the recording head to be used. With increasing coercive force, overwriting of signals poses a problem. Since the coercive force of the ferromagnetic metal powders primarily originates in the anisotropy of configuration, the variation coefficient of configuration is preferably small.

Preferable hexagonal ferrite magnetic powders are magnetoplumbite structural (M-type) hexagonal ferrites including barium ferrite, strontium ferrite, lead ferrite, calcium ferrite, and various substitution products of these ferrites. In addition to the prescribed atoms, the hexagonal ferrite powders may contain atoms such as Al, Si, S, Sc, Ti, V, Cr, Cu, Y, Mo, Rh, Pd, Ag, Sn, Ba, Ta, W, Re, Au, Pb, Bi, La, Ce, Pr, Nd, P, Co, Mn, Zn, Ni, Sr, B, Ge, Nb, etc. Typically, hexagonal ferrite powders containing certain elements, including but not limited to Co—Ti, Co—Ti—Zr, Co—Nb, Co—Ti—Zn, Co—Zn—Nb, Ni—Ti—Zn, Nb—Zn, Ni—Ti, Zn—Ti and Zn—Ni, can be used. From the viewpoint of SFD, pure M-type ferrites are preferred to composite type ferrites full of spinel phase. Techniques for controlling the coercive force include such as controlling the composition, tabular diameter and tabular thickness of hexagonal ferrite; controlling the thickness of a spinel phase; controlling the amount of the substitution element of a spinel phase; and controlling the position of the substitution site of a spinel phase.

The hexagonal ferrite magnetic powders for use in the present invention preferably have an average tabular diameter of from 15 to 35 nm; a variation coefficient of tabular diameters of from 0 to 30%. Further, an average tabular thickness of the magnetic powders is typically from 2 to 15 nm. However, in the present invention, the average tabular thickness is particularly preferably in the range of 4 to 10 nm. In addition, an average tabular ratio thereof is preferably in the range of 1.5 to 4.5, more preferably in the range of 2 to 4.2. The hexagonal ferrite magnetic powders having the average tabular diameter within the aforementioned range is desirable, because the specific surface area becomes an appropriate value so that the hexagonal ferrite powders can be easily dispersed. The hexagonal ferrite magnetic powders have a specific surface area (S_{BET}) preferably in the range of 40 to 100 m²/g, more preferably in the range of 45 to 90 m²/g. Selecting the specific surface area within this range lowers noise and facilitates dispersion of the hexagonal ferrite powders, which results in improvement in surface property. The hexagonal ferrite magnetic powders preferably have a moisture content within the range of 0.3 to 2.0%. It is preferred to optimize the moisture content of the magnetic powders depending on the kind of a binder. The pH of the hexagonal ferrite magnetic powders is preferably optimized depending on the combination with a binder to be used. A preferred range of the pH is from 5.0 to 12, and preferably from 5.5 to 10.

These ferromagnetic powders may be subjected to treatment in advance before dispersion with the later-described dispersant, lubricant, surfactant and antistatic agent.

The SFD of the ferromagnetic powders themselves is preferably small, and it is necessary to make the distribution of Hc of the ferromagnetic powders small. When the SFD of a tape is small, magnetic flux revolution is sharp and peak shift becomes small, so that the tape is suitable for high density digital magnetic recording. Techniques for reducing the Hc distribution include; making the particle size distribution of goethite in ferromagnetic metal powders good; using monodispersed α-Fe₂O₃, and preventing sintering among particles.

[Lower Layer]

In the following, a description will be given on the lower layer. It is preferable that the lower layer is mainly composed of nonmagnetic inorganic powder and a binder. The nonmagnetic inorganic powder for use in the lower layer can be selected from inorganic compounds including, but not limited to, metallic oxide, metallic carbonate, metallic sulfate, metallic nitride, metallic carbide and metallic sulfide. Because of the narrow particle-size distribution, presence of various means for imparting functions and other reasons, especially preferred are titanium dioxide, zinc oxide, iron oxide and barium sulfate, and more preferred are titanium dioxide and α-iron oxide. These nonmagnetic inorganic powders preferably have an average particle size within the range of 0.005 to 2 μm. However, if necessary, a plurality of types of nonmagnetic inorganic powders each having a different average particle size, may be combined, or a single nonmagnetic inorganic powder having a broad particle size distribution may be used such that the same effect as that of the combination is achieved. A particularly preferred average particle size of the nonmagnetic inorganic powders is within the range of 0.01 to 0.2 μm. In particular, when the nonmagnetic inorganic powders are granular metallic oxides, the average particle size of the granular metallic oxides is preferably 0.08 μm or less, and when nonmagnetic inorganic powders are acicular metallic oxides, the average long axis length of the acicular metallic oxides is preferably 0.3 μm or less, and more preferably 0.2 μm or less. A tap density of the nonmagnetic inorganic powders for use in, the present invention is typically in the range of 0.05 to 2 g/ml, and preferably in the range of 0.2 to 1.5 g/ml. A moisture content of the nonmagnetic inorganic powders, is typically in the range of 0.1 to 5% by mass, preferably in the range of 0.2 to 3% by mass, and more preferably in the range of 0.3 to 1.5% by mass. A pH value of the nonmagnetic inorganic powders is typically in the range of 2 to 11, and particularly preferably in the range of 5.5 to 10. A specific surface area of the nonmagnetic inorganic powders is typically in the range of 1 to 100 m²/g, preferably in the range of 5 to 80 m²/g, and more preferably in the range of 10 to 70 m²/g.

A crystallite size of the nonmagnetic inorganic powders is preferably in the range of 0.004 to 1 μm, and more preferably in the range of 0.04 to 0.1 μm. An oil absorption amount thereof when using DBP (dibutyl phthalate) is typically in the range of 5 to 100 ml/100, g, preferably in the range of 10 to 80 ml/100 g, and more preferably in the range of 20 to 60 ml/100 g; and a specific gravity thereof is typically in the range of 1 to 12, and preferably in the range of 3 to 6. The nonmagnetic inorganic powders can be of any of acicular, spherical, polyhedral and tabular in shape. A Mohs' hardness of the nonmagnetic inorganic powders is preferably in the range of 4 to 10; an adsorption amount of SA (stearic acid) thereof is typically in the range of 1 to 20 μmol/m², preferably in the range of 2 to 15 μmol/m², and more preferably in the range of 3 to 8 μmol/m²; and a pH value thereof is preferably in the range of 3 to 6. The surfaces of the nonmagnetic inorganic powders may be attached with Al₂O₃, SiO₂, TiO₂, ZrO₂, SnO₂, Sb₂O₃, ZnO or Y₂O₃, by surface treatment. Among them, Al₂O₃, SiO₂, TiO₂ and ZrO₂ are preferred in the point of dispersibility, and Al₂O₃, SiO₂ and ZrO₂ are more preferred. These compounds may be used alone or in combination. Surface treatment may be performed according to purpose by coprecipitation, or by covering particle surfaces with alumina and silica in this order, or vice versa. The treated surface layer may be porous, if necessary, but a homogeneous and dense layer is generally desirable.

By mixing carbon blacks into the lower layer, reduction of surface electrical resistance (Rs) and light transmittance, which, is a well known effect, can be achieved, and hence a desired micro Vickers hardness can be obtained. Incorporating the carbon blacks into the lower layer can bring about an effect of storing a lubricant. Examples of the carbon blacks that can be used include furnace blacks for rubbers, thermal blacks for rubbers, carbon blacks for coloring and acetylene blacks. The carbon blacks used in the lower layer should optimize the characteristics as described below according to the desired effects. Using the different types of the carbon blacks in combination may bring out a more beneficial effect.

A specific surface area of the carbon blacks for use in the lower layer is typically in the range of 100 to 500 m²/g, and preferably in the range of 150 to 400 m²/g; and a DBP oil absorption amount thereof is typically in the range of 20 to 400 ml/100 g, and preferably in the range of 30 to 400 ml/100 g. An average particle size of the carbon blacks is typically in the range of 5 to 80 nm, preferably in the range of 10 to 50 nm, and more preferably in the range of 10 to 40 nm. A small amount of carbon blacks having an average particle size of 80 nm or greater may be contained. It is preferred that the carbon blacks have a pH value in the range of 2 to 10, a moisture content in the range of 0.1 to 10%, and a tap density in the range of 0.1 to 1 g/ml.

Specific examples of the carbon blacks for use in the lower layer are disclosed, for example, in WO 98/35345. These carbon blacks can be used in the range not exceeding 50% by mass based on the aforementioned nonmagnetic inorganic powders (riot including the carbon blacks) and not exceeding 40% based on the total mass of the nonmagnetic layers. Different types of the carbon blacks can be used alone or in combination. Regarding the carbon blacks that can be used in the present invention, “Carbon Black Binran (Handbook of Carbon Blacks)” The Carbon Black Society of Japan (ed.) can be referred to.

Organic powders, including acrylic styrene resin powders, benzoguanamine resin powders, melamine resin powders and phthaiocyanine pigments, can be mixed into the lower layer according to purpose. Alternatively or in addition, polyolefin resin powders, polyester resin powders, polyamide resin powders, polyimide resin powders and polyethylene fluoride resin powders can be used.

Binder resins, lubricants, dispersants, additives, solvents, dispersing methods and others used in a magnetic layer described later can be used for the lower layer. In particular, with respect to the amounts and the kinds of binder resins, additives, the amounts and the kinds of dispersants, any of a variety of techniques regarding the magnetic layer can be similarly applied to the lower layer.

[Binder]

A binder used in the present invention is selected from the group consisting of conventionally known thermoplastic resins, thermosetting resins, reactive resins and mixtures of thereof.

The thermoplastic resins used in the present invention have a glass transition temperature in the range of −100 to 150° C.; a number average molecular weight in the range of 1,000 to 200,000, preferably in the range of 10,000 to 100,000; and a polymerization degree in the range of about 50 to about 1,000.

Examples of the thermoplastic resins include, but are not limited to, polymers or copolymers containing, as the constituting unit, vinyl chloride, vinyl acetate, vinyl alcohol, maleic acid, acrylic acid, acrylic ester, vinylidene chloride, acrylonitrile, methacrylic acid, methacrylic ester, styrene, butadiene, ethylene, vinyl butyral, vinyl acetal or vinyl ether; polyurethane resins; and various rubber resins. Examples of the thermosetting resins and reactive resins include, but are not limited to, phenolic resins, epoxy resins, curable type polyurethane resins, urea resins, melamine resins, alkyd resins, acrylic reactive resins, formaldehyde resins, silicone resins, epoxy-polyamide resins mixtures of polyester resins and isocyanate prepolymers, mixtures of polyesterpolyol and polyisocyanate, and mixtures of polyurethane and polyisocyanate. These resins are described in detail in “Plastic Handbook”, Asakura Shoten. It is also possible to use any of a variety of electron beam-curable type resins in each layer. Examples of these resins and manufacturing methods are disclosed in detail in Japanese Unexamined Patent Publication No. 62(1987)-256219. These resins can be used alone or in combination. Examples of the preferred combinations include: combinations of at least one resin selected from vinyl chloride resins, vinyl chloride-vinyl acetate copolymers, vinyl chloride-vinyl acetate-vinyl alcohol copolymers, and vinyl chloride-vinyl acetate-maleic anhydride copolymers with a polyurethane resin; and combinations of these resins with polyisocyanate.

Polyurethane resins having well known structures, including but not limited to polyester polyurethane, polyether polyurethane, polyether polyester polyurethane, polycarbonate polyurethane, polyester polycarbonate polyurethane, and polycaprolactone polyurethane, can be used. In order to obtain more excellent dispersibility and durability for all of the binders described above, it is preferred to use binders into which at least one polar group Selected from —COOM, —SO₃M, —OSO₃M, —P═O(OM)₂, O—P═O(OM)₂ (wherein M represents a hydrogen atom or an alkali metal salt group), —NR₂, —N⁺R₃ (wherein R represents a hydrocarbon group), an epoxy group —SH and —CN is included by copolymerization or addition reaction, according to necessity. The amount of the polar group so added is from 10⁻¹ to 10⁻⁸ mol/g, preferably from 10⁻² to 10⁻⁵ mol/g. It is preferred for polyurethane resins to have at least One OH group at each terminal of a polyurethane molecule, i.e., two or more in total, besides the polar groups. Since OH groups form a three dimensional network structure by crosslinking with a polyisocyanate that is a curing agent, the larger number of OH groups contained in its molecule are more desirable. In particular, it is preferred that OH groups are present at terminals of its molecule, since the reactivity with the curing agent is higher than otherwise. It is preferred for polyurethane to have three or more OH groups, particularly preferably four or more OH groups, at a terminal of its molecule. When polyurethane is used in the present invention, the glass transition temperature of polyurethane desirably employed herein is typically in the range of −50 to 150° C., preferably in the range of 0 to 100° C., and particularly preferably in the range of 30 to 100° C. Further, it is also preferred that the breaking extension thereof is in the range of 100 to 2,000%, the breaking stress thereof is in the range of 0.05 to 10 kg/mm² (about 0.49 to 98 MPa), and the yielding point thereof is in the range of 0.05 to 10 kg/mm² (about 0.49 to 98 MPa). Due to these physical properties, a coating film having good mechanical properties can be obtained.

Specifically, examples (by product name) of the binders for use in the present invention include: MR-104, MR-105, MR-110, MR-100, MR-555 and 400X-110A (each manufactured by Nippon Zeon Co., Ltd.); Nippollan N2301, N2302 and N2304 as polyurethane resins (each manufactured by Nippon Polyurethane Co., Ltd.); Pandex T-5105, T-R3080, T-5201, Burnock D-400, D-210-80, Crisvon 6109 and 7209 (each manufactured by Dainippon Ink and Chemicals Inc.); and Vylon UR8200, UR8300, UR8700, RV530 and RV280 (each manufactured by Toyobo Co., Ltd.).

The amounts of the binders for use in the nonmagnetic layer and the magnetic layer are in the range of 5 to 50% by mass, and preferably in the range of 10 to 30% by mass, respectively based on the nonmagnetic inorganic powder and the magnetic powder. When vinyl chloride resins, polyurethane resins and polyisocyanate are used in combination, vinyl chloride resins should preferably be within the range of 5 to 30% by mass, polyurethane resins should preferably be within the range of 2 to 20% by mass, and polyisocyanate should preferably be within the range of 2 to 20% by mass. However, for instance, in the case where the corrosion of heads is caused by a slight amount of chlorine due to dechlorination, it is also possible to use only polyurethane alone or a combination of polyurethane and polyisocyanate.

A variety of polyisocyanate compounds that can be used in the present invention are currently available. These compounds May be used alone, or in combination of two or more in each layer taking advantage of the difference in curing reactivity.

[Carbon Black, Abrasive]

Examples of the carbon blacks for use in the magnetic layer in the present invention include furnace blacks for rubbers, thermal blacks for rubbers, carbon blacks for coloring, and, acetylene blacks. Carbon blacks for use in the present invention should preferably have a specific surface area in the range of 5 to 500 m²/g, a DBP oil absorption amount in the range of 10 to 400 ml/100 q, an average particle size in the range of 5 to 300 nm, a pH value in the range of 2 to 10, a moisture content in the range of 0.1 to 10%, and a tap density in the range of 0.1 to 1 g/ml. Specific examples of these carbon blacks are disclosed in WO 98/35345.

Carbon blacks can serve various functions such as prevention of static charges of a magnetic layer, reduction of a friction coefficient, impartation of a light-shielding property and improvement of film strength. The function produced depends upon the type of carbon black used. Accordingly, when the present invention employs a multilayer structure, it is of course possible to properly select and determine the kinds, the amounts and the combinations of the carbon blacks to be added to each layer on the basis of the above-described various properties such as the particle size, the oil absorption amount, the electrical conductance and the pH value. Rather, they should be optimized in each layer.

According to the present invention, diamond particles are used as an abrasive for the magnetic layer of the magnetic disk 4 of the present invention. Specifically, a magnetic layer is formed which contains 1% to 10% by weight, with respect to the ferromagnetic material, of diamond particles which have an average particle size satisfying the following formula;
b−0.05≦a≦b+0.1 (Formula 1)
where “a” represents an average particle size of the diamond particles in units of μm and “b” represents a thickness of the magnetic layer in units of μm.

When the magnetic layer containing the aforementioned abrasive is formed, a good dust-removal effect can be achieved by a liner 6 without flawing the magnetic disk 4 and without increasing the rotary torque of the magnetic disk 4. Experimental results which show the foregoing effects will be described later.

Any abrasives other than diamond particles may be used in combination in the magnetic layer. Any of a variety of well-known materials essentially having a Mohs′ hardness of 6 or higher, including but not limited to α-alumina having an α-conversion rate of 90% or more, β-alumina, silicon carbide, chromium oxide, cerium oxide, α-iron oxide, corundum, silicon nitride, titanium carbide, titanium oxide, silicon dioxide and boron nitride, can be used as abrasives in the magnetic layer alone or in combination. The composites of these abrasives (abrasives obtained by surface-treating with other abrasives) may also be used. While it sometimes possible that compounds or elements other than their main components are contained in abrasives, the intended effects can be attained so long as the content of main component is 90% or more. These abrasives preferably have an average particle size of from 0.01 to 2 μm and, in particular, for improving electromagnetic characteristics, a narrower particle size distribution is preferable. To improve durability, abrasives different in particle size may be combined according to necessity, or a single abrasive having broad particle size distribution may be used so as to attain the same effect as such a combination. Abrasives employed here preferably have a tap density in the range of 0.3 to 2 g/ml, a moisture content in the range of 0.1 to 5%, a pH value in the range of 2 to 11, and a specific surface area in the range of 10 to 50 m²/g. The configurations of the abrasives for use in the present invention may be any of acicular, spherical and die-like configurations, but those having an edge at a part thereof are preferred for their high abrasive property. Specific examples of these abrasives are disclosed in WO 98/35345. The particle sizes and the amounts of the abrasives to be added to the magnetic layer and the nonmagnetic layer should be independently set at optimal values.

[Additive]

As additives for use in the magnetic layer and the nonmagnetic layer in the present invention, those having a lubricating effect, an antistatic effect, a dispersing effect, a plasticizing effect, etc. are used, and the overall performance can be increased by a combination of the additives. As additives having a lubricating effect, lubricants giving a remarkable action on agglutination caused by the friction of surfaces of materials with each other are used. Lubricants are roughly classified into two types. Lubricants, that are used for magnetic disks cannot be determined whether they show completely fluid lubrication or boundary lubrication, but according to general concept they are classified into a type showing fluid lubrication, including higher fatty acid esters, liquid paraffin and silicon derivatives; and a type showing boundary lubrication, including long chain fatty acids, fluorine surfactants and fluorine-containing polymers. In a coating type magnetic-recording medium, a lubricant exists in a state dissolved in a binder or in a state of partly being adsorbed onto the surface of hexagonal ferrite magnetic powder. The lubricant migrates to the surface of a magnetic layer, wherein the speed of migration varies depending upon whether or not the compatibility of the binder and the lubricant is good. The speed of migration is slow when the compatibility of the binder and the lubricant is good, whereas the migration speed is fast when the compatibility is bad. One method of evaluation on good or bad of the compatibility is to compare dissolution parameters of the binder and the lubricant. A nonpolar lubricant is effective for fluid lubrication, while a polar lubricant is effective for boundary lubrication.

In the present invention, it is preferred to use in combination a higher fatty acid ester showing fluid lubrication and a long chain fatty acid showing boundary lubrication each having different characteristics, and it is more preferred to combine at least three of these lubricants. Solid lubricants can also be used in combination with these lubricants.

Examples of the aforementioned solid lubricants include molybdenum disulfide, tungsten disulfide graphite, boron nitride, and graphite fluoride. Examples of the long chain fatty acids showing boundary lubrication include monobasic fatty acids having from 10 to 24 carbon atoms (they may contain an unsaturated bond or may be branched), and metal salts of these monobasic fatty acids (e.g., with Li, Na, K or Cu). Examples of the fluorine surfactants and fluorine-containing polymers include fluorine-containing silicones, fluorine-containing alcohols, fluorine-containing esters, fluorine-containing alkyl sulfates, and alkali metal salts of these compounds. The examples of higher fatty acid esters showing fluid lubrication include fatty acid monoesters, fatty acid diesters and fatty acid triesters composed of a monobasic fatty acid having from 10 to 24 carbon atoms (which may contain an unsaturated bond or may be branched) and any one of mono-, di-, tri-, tetra-, penta- and hexa-alcohols having from 2 to 12 carbon atoms (which may contain an unsaturated bond or may be branched), and fatty acid esters of monoalkyl ethers of alkylene oxide polymers. In addition to the above, the examples further include liquid paraffin, and as silicon derivatives, silicone oils such as dialkylpolysiloxane (the alkyl group has from 1 to 5 carbon atoms), dialkoxypolysiloxane (the alkoxyl group has from 1 to 4 carbon atoms), monoalkyl-monoalkoxypolysiloxane (the alkyl group has from 1 to 5 carbon atoms and the alkoxyl group has from 1 to 4 carbon atoms), phenylpolysiloxane, and fluoroalkylpolysiloxane (the alkyl group has from 1 to 5 carbon atoms), silicones having a polar group, fatty acid-modified silicones, and fluorine-containing silicones.

Examples of other lubricants include alcohols, e.g., mono-, di-, tri-,, tetra-, penta- and hexa-alcohols having from 12 to 22 carbon atoms (they may contain an unsaturated bond or may be branched), alkoxy alcohols having from 12 to 22 carbon atoms (they may contain an unsaturated bond or may be branched), and fluorine-containing alcohols, polyethylene waxes, polyolefins such as polypropylene, ethylene glycols, polyglycols such as polyethylene oxide waxes, alkyl phosphates and alkali metal salts of alkyl phosphates, alkyl sulfates and alkali metal salts of alkyl sulfates, polyphenyl ethers, fatty acid amides having from 8 to 22 carbon atoms, and aliphatic amines having from 8 to 22 carbon atoms.

Examples of the additives having an antistatic effect, a dispersing effect and a plasticizing effect include phenylphosphonic acid, specifically “PPA” (manufactured by Nissan Chemical Industries, Ltd.), α-naphthylphosphoric acid, phenylphosphoric acid, diphenylphosphoric acid, p-ethyl-benzenephosphonic acid, phenylphosphinic acid, aminoquinones, various kinds of silane coupling agents, titanium coupling agents, fluorine-containing alkyl sulfates and alkali metal salts of these compounds.

Lubricants that are particularly preferably used in the present invention are fatty acids and fatty acid esters, and specific examples of such lubricants are disclosed in WO 98/35345. Besides the above, other different lubricants and additives can be used in combination as well.

The surface of the magnetic layer in the present invention has a C/Fe peak ratio measured by Auger electron spectroscopy of preferably in the range of 5 to 100, particularly preferably in the range of 5 to 80. The measuring conditions of the C/Fe peak ratio by Auger electron spectroscopy are as follows.

Instrument: Model PHI-660, manufactured by Φ Co.

Measuring Conditions:
Primary electron beam accelerating voltage: 3 KV
Electric current of sample: 130 nA
Magnification: 250-fold
Inclination angle: 30°

The value of C/Fe peak ratio is obtained as the C/Fe ratio by integrating the values obtained under the above-listed conditions in the region of kinetic energy of 130 eV to 730 eV three times and finding the strengths of KILL peak of the carbon and LMM peak of the iron as differentials.

The amount of the lubricants contained in each of an upper layer and a lower layer of the magnetic disk of the present invention is preferably in the range of 5 to 30 mass parts per 100 mass parts of: the ferromagnetic powder and the nonmagnetic inorganic powder, respectively.

Lubricants and surfactants for use in the present invention individually have different physical functions. The kinds, amounts and combining proportions bringing about synergistic effects of these lubricants should be determined optimally in accordance with a purpose. By way of example only, a nonmagnetic layer and a magnetic layer can separately contain different fatty acids each having a different melting point so as to prevent bleeding out of the fatty acids to the surface, or different esters each having a different boiling point, a different melting point or a different polarity so as to prevent bleeding out of the esters to the surface; the amount of the surfactant is controlled so as to improve the coating stability; and the amount of the lubricant in the intermediate layer can be made larger so as to improve the lubricating effect. In general, the total amount of lubricants is selected from the range of 0.1% by mass to 50% by mass, preferably in the range of 2% by mass to 25% by mass, based on the amount of the ferromagnetic powder or the nonmagnetic powder.

All or a part of the additives to be used in the present invention may be added to a magnetic coating solution or a nonmagnetic coating solution in any step of preparation. For example, additives may be blended with magnetic powder before a kneading step, may be added in a step of kneading magnetic powder, a binder and a solvent, may be added in a dispersing step, may be added after a dispersing step, or may be added just before coating. According to the purpose, there are cases of capable of attaining the object by coating all or a part of additives simultaneously with or successively after the coating of a magnetic layer. Further, according to purpose, a lubricant may be coated on the surface of a magnetic layer after calendering treatment or after completion of slitting.

[Layer Constitution]

The thickness of the substrate of the magnetic disk 4 in the present invention is typically in the range of 2 to 100 μm, preferably in the range of 2 to 80 μm.

An undercoat layer may be provided between the substrate, preferably a nonmagnetic flexible substrate, and a nonmagnetic or magnetic layer in order to enhance adhesion therebetween. The thickness of the undercoat layer is in the range of 0.01 to 0.5 μm, preferably in the range of 0.02 to 0.5 μm.

A backing layer may be provided on the side of the substrate opposite to the side having a magnetic layer in order to produce certain effects including static charge prevention and curling correction. The thickness of the backing layer is typically in the range of 0.1 to 4 μm., preferably in the range of 0.3 to 2.0 μm. Any of a variety of well-known undercoat layers and backing layers can be used for this purpose.

Further, a double-sided magnetic disk may be produced which has a nonmagnetic layer and a magnetic layer on each side of its substrate.

While the thickness of a magnetic layer having the constitution comprising a lower layer and an upper layer in the present invention is as described above, the thickness is optimized by the amount of saturation magnetization of the head to be used, the head gap length and the recording signal zone. The thickness of a lower layer is typically in the range of 0.2 to 5.0 μm, preferably in the range of 0.3 to 3.0 μm and more preferably in the range of 1.0 to 2.5 μm.

A lower layer exhibits the effect of the present invention so long as it is substantially nonmagnetic even if, or intentionally, it contains a small amount of magnetic powder as the impurity, which can be as a matter of course regarded as essentially the same constitution as in the present invention. As used herein, the term “substantially nonmagnetic” means that the residual magnetic flux density of a lower layer is 10 mT or less or the coercive force of a lower layer is 100 Oe (about 8 kA/m) or less, preferably the residual magnetic flux density and the coercive force are zero. When the lower layer contains magnetic powder, the content of the magnetic powder, is preferably less than ½ of the total inorganic powders contained in the lower layer. In place of a nonmagnetic layer, a soft magnetic layer containing soft magnetic powder and a binder may be formed as a lower layer. The thickness of the soft magnetic layer is the same as the thickness of the aforementioned lower layer.

Further, the substrate for use in the present invention is preferably a nonmagnetic flexible substrate, and essentially has a thermal shrinkage factor of preferably 0.5% or less at 100° C. for 30 minutes, and of preferably 0.5% or less at 80° C. for 30 minutes, more preferably 0.2% or less, in every planar direction of the substrate. Further, the thermal shrinkage factors of the substrate at 100° C. for 30 minutes and at 80° C. for 30 minutes are preferably almost equal in every planar direction of the substrate with a difference of not more than 10%. The substrate is preferably a nonmagnetic substrate. As such nonmagnetic substrates, any of a variety of well-known films such as of polyesters (e.g. polyethylene terephthalate and polyethylene naphthalate), polyolefins, cellulose triacetate, polycarbonate, aromatic or aliphatic polyamide, polyimide, polyamideimide, polysulfone and polybenzoxazole can be used. High-strength substrates such as polyethylene naphthalate and polyamide are preferably used if necessary, a lamination type substrate as disclosed in Japanese Unexamined Patent Publication No. 3(1991)-224127 can be used to vary the surface roughness of a magnetic layer surface and a base surface. These substrates may be subjected in advance to corona discharge treatment, plasma treatment, adhesion assisting treatment, heat treatment, dust-removing treatment or the like.

More specifically, it is preferred to use a substrate having a central plane average surface roughness (Ra) of 4.0 nm or less, preferably 2.0 nm or less, when measured by a surface roughness meter TOPO-3D manufactured by WYKO Co. It is preferred that the substrate not only has a small central plane average surface roughness but also is free from coarse spines having heights of 0.5 μm or more. Surface roughness configuration is freely controlled by the size and the amount of a filler added to the substrate as required. Examples of such fillers include oxides and carbonates of Ca, Si and Ti, and acrylic-based organic powders. A substrate for use in the present invention preferably has a maximum height (Rmax) of 1 μm or less, a ten point average roughness (Rz) of 0.5 μm or less, a central plane peak height (Rp) of 0.5 μm or less, a central plane valley depth (Rv) of 0.5 μm or less, a central plane area factor (Sr) within the range of 10% to 90%, and average Wavelength (λa) within the range of 5 to 300 μm. For obtaining desired electromagnetic characteristics and durability, the spine distribution on the surface of the substrate can be controlled arbitrarily by using fillers. For example, the number of spines having sizes within the range of 0.01 to 1 μm can be controlled each within the range of 0 to 2,000 per 0.1 mm².

In addition, the substrates for use in the present invention have an F-5 value preferably in the range of 5 to 50 kg/mm² (about 49 to 490 MPa), a thermal shrinkage factor at 100° C. for 30 minutes of preferably 3% or less, more preferably 1.5% or less, and a thermal shrinkage factor at 80° C. for 30 minutes of preferably 1% or less, more preferably 0.5% or less. The substrates further have a breaking strength preferably in the range of 5 to 100 kg/mm² (about 49 to 980 MPa), an elastic modulus preferably in the range of 100 to 2,000 kg/mm² (about 0.98 to 19.6 GPa), a temperature expansion coefficient preferably in the range of 10⁻⁴ to 10⁻⁸/° C., more preferably in the range of 10⁻⁵ to 10⁻⁶/° C., and a humidity expansion coefficient of preferably 10⁻⁴/RH % or less, more preferably 10⁻⁵/RH % or less. These thermal, dimensional and mechanical strength characteristics are preferably almost equal in every direction within the plane of the substrates with differences of not more than 10%.

Manufacturing Method

A process of manufacturing a magnetic coating solution for the magnetic disk 4 in the present invention comprises at least a kneading step, a dispersing step and optionally a blending step to be carried out before and/or after the kneading and dispersing steps. Each step may be composed of two or more separate stages. All the feedstock such as magnetic powder, nonmagnetic powder, a binder, a carbon black, an abrasive, an antistatic agent, a lubricant and a solvent for use in the present invention may be added at the beginning or during the course of any step. Further, each feedstock may be added at two or more steps dividedly. For example, polyurethane can be added dividedly at a kneading step, a dispersing step, or a blending step for adjusting viscosity after dispersion. In addition, conventionally well-known techniques can be performed partly with the above steps. Powerful kneading machines such as an open kneader, a continuous kneader, a pressure kneader and an extruder are preferably used in the kneading step. When a kneader is used, all or a part of the binder (preferably 30% or more of the total binder) is kneaded in the range of 15 to 500 parts per 100 parts of the magnetic powder together with the magnetic powder or nonmagnetic powder. These kneading treatments are disclosed in detail in Japanese Unexamined Patent Publication Nos. 1(1989)-106338 and 1(1989)-79274. For dispersing a magnetic layer coating solution and a nonmagnetic layer coating solution, glass beads can be used. Zirconia beads, titania beads and steel beads, all of which are dispersing media having a high specific gravity, are preferred. Optimal particle size and packing density of these dispersing media should be selected. Any of a variety of well-known dispersers may be used.

After the coating solution prepared as described above is coated over the substrate, the magnetic disk is subjected to orientation treatment as desired.

The magnetic disk 4 may obtain an isotropic orienting property without performing orientation with orientating apparatus. However, it is preferred to use any of a variety of well-known random orientation techniques including to dispose cobalt magnets diagonally and to apply an alternating current magnetic field with a solenoid. Hexagonal ferrite magnetic powders is sometimes prone to random three-dimensional orientations in the planar and in the perpendicular directions, however, it is also possible to make random two-dimensional orientations in the planar direction. It is also possible to impart isotropic magnetic characteristics in the circumferential direction by perpendicular orientation using well-known methods, e.g., using different pole and counter position magnets. In particular, the perpendicular orientation is preferred when the disk is subjected to high density recording. A circumferential orientation can be adopted by using a spin coat technique.

After coating and drying, the web having a coated layer is preferably subjected to calendering treatment.

Heat resistive plastic rolls such as of epoxy, polyimide, polyamide and polyimideamide or metal rolls are used as calendering rolls. Metal rolls are preferably used for the treatment particularly when magnetic layers are coated on both sides of the substrates. The treatment temperature is preferably at least 50° C., and more preferably at least 100° C. The linear pressure is preferably 200 kg/cm (about 196 kN/m) or more, more preferably 300 kg/cm (about 294 kN/m) or more.

[Physical Properties]

For the magnetic disk 4, it is preferred that (residual magnetic flux density)×(magnetic layer thickness of the magnetic disk) is preferably in the range of 5 to 300 mT·μm. The coercive force (Hc) is preferably in the range of 1,800 to 5,000 Oe (about 144 to 400 kA/m), more preferably in the range of 1,800 to 3,000 Oe (about 144 to 240 kA/M). The distribution of the coercive force is preferably narrow, and SFD (switching field distribution) and SFDr are preferably 0.6 or less.

The squareness ratio of the magnetic disk is as follows: in the case of two dimensional random orientation, typically in the range of 0.55 to 0.67, and preferably in the range of 0.58 to 0.64; in the case of three dimensional random orientation, in the range of 0.45 to 0.55; in the case of perpendicular orientation, typically 0.6 or more in the perpendicular direction, and preferably 0.7 or more; and in the case of performing diamagnetic correction, typically 0.7 or more, and preferably 0.8 or more. Degree of orientation in two-dimensional random orientation and three-dimensional random orientation is preferably 0.8 or more. In the case of two-dimensional random orientation, the squareness ratio in the perpendicular direction, the Br in the perpendicular direction, and the Hc in the perpendicular direction are preferably selected such that they fall within the range of 0.1 to 0.5 times of those in the planar direction.

The residual amount of a solvent in a magnetic layer is preferably 100 mg/m², or less, and more preferably 10 mg/m² or less. The void ratio of the upper and lower coated layer is preferably 30% by volume or less, more preferably 20% by volume or less. While a smaller void ratio is preferable for obtaining higher output, in some cases a specific value should be preferably secured depending on purposes. For example, in a disk medium for which the ability to withstand repeated use is important, a large void ratio contributes to good running durability in many cases.

A central plane average surface roughness (Ra) of the surface of the magnetic layer when measured with a surface roughness meter TOPO-3D manufactured by WYKO is preferably 5.0 nm or less, more preferably 4.0 nm or less; and especially preferably 3.5 nm or less. The magnetic layer preferably has a maximum height (Rmax) of 0.5 μm or less, a ten point average roughness (Rz) of 0.3 μm or less, a central plane peak height (Rp) of 0.3 μm or less, a central plane valley depth (Rv) of 0.3 μm or less, a central plane area factor (Sr) within the range of 20 to 80%, and average wavelength (λa) within the range of 5 to 300 μm. The surface spine, having sizes of 0.01 to 1 μm, of a magnetic layer can be controlled arbitrarily within the range of 0 to 2,000, and it is preferred to optimize the surface spines. The surface spines can be easily controlled by the control of the surface property of a substrate by using fillers, the particle size and amount of the magnetic powders added to the magnetic layer, or by the surface configurations of the rolls for calendering. Curing is preferably within ±3 mm. It is easily conceivable that these physical characteristics of the upper and lower layers of the magnetic disk 4 can be varied according to the purpose. For example the elastic modulus of the upper layer is made higher to improve running durability and at the same time the elastic modulus of the lower layer is made lower than that of the upper layer to improve the head touching of the magnetic disk.

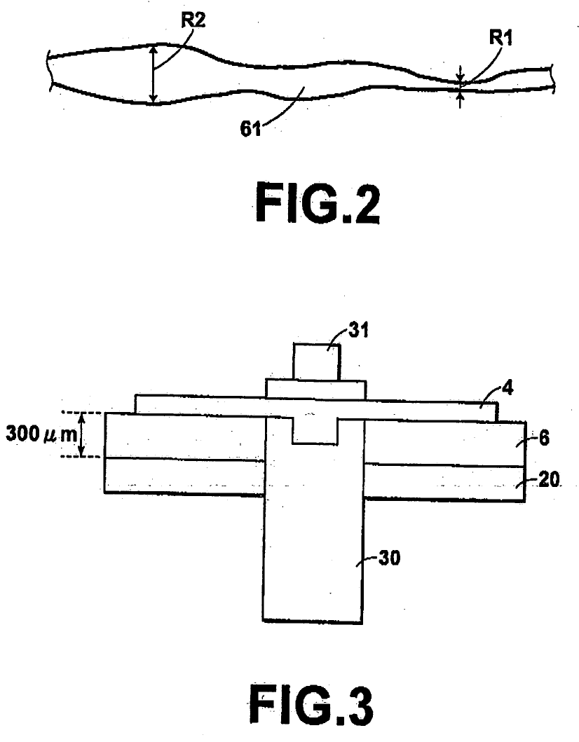

In the following, a description will be given on the liners 6. It is desirable that the liners 6 are those composed of polyethylene terephthalate fibers. Specifically, examples, of such liner materials includes; woven fabric consisting of extra fine and long polyester fibers such as “TORACY™” (Toray Industries); nonwoven fabric consisting of long polyester fibers such as “LTAS (polyester)™” (Asahi Chemical); pressure-applied nonwoven fabric consisting of long polyester fibers such as “LTAS (polyesters EH5045 and,EH5045C)™” (Asahi Chemical); resin-coated nonwoven fabric consisting of long polyester fibers such as “LTAS (polyester E01100)™” (Asahi Chemical); and resin-coated nonwoven fabric consisting of long polyester fibers such as “LTAS (polyester E01100)™” (Dai Nihon Jochugiku). Further, as shown in FIG. 2, the liner materials should preferably have fibers 61 whose diameter varies in the length direction of the fiber. Further, it is also desirable that the minimum diameter R1 of the liners 6 shown in FIG. 2 is within the range of 5% to 60% of the maximum fiber diameter R2.

It should be understood that the present invention is not limited to the foregoing embodiments. For example, while the magnetic disk cartridge shown in FIG. 1, to which the present invention is applied, is a so-called 3.5″ floppy disk cartridge, the present invention is not limited thereto. The present invention may be applied, for example, to a very small magnetic disk cartridge as disclosed in PCT Japanese Translation Patent Publication No. 2001-523033 which comprises a flat housing (width 50 mm, depth 6.6 mm, and thickness 1.95 mm) having a housing formed of a flat thin metal sheet and rotatably accommodates therein a flexible magnetic disk, e.g. a 1.8 inch (about 46.5 mm) diameter magnetic disk to which a center core is affixed. Further, in the foregoing embodiments, a magnetic disk having a surface recording density of at least 158.7 Mbit/cm2 is used as the magnetic disk 4. However, the magnetic disk 4 may be those having a track density of not less than 10 Ktpi or a track recording density of not less than 100 Kbpi.

In the following, a description will be given on examples of the magnetic disk cartridges according to the present invention.

Magnetic disk cartridge samples, respectively having various magnetic disks which have different magnetic layer thicknesses b (μm) and contain diamond particles of different particle sizes a (μm) and different amounts added in the magnetic layer, were provided. These magnetic disk cartridges were then subjected to evaluations on their running durability, production of liner debris, and increase of magnetic disk rotary torque. Table 1 shows the results. First, a method of producing the samples of the magnetic disk 4 will be described.

TABLE 1

| | | | a(μm) − B(μm) | Average | | | | | |
|---|---|---|---|---|---|---|---|---|---|
| | | | a(μm): Ave. Part. | Particle | Thickness | | | | |
| | | Variation | Size of Diamond | Size of | of Magnetic | Amount of | | | |
| | Fibrous | in Fiber | B(μm): Thickness | Diamond | Layer | Diamond | Running | Liner | Increase of |
| Sample | Material | Dia. | of Magnetic Layer | a(μm) | B(μm) | (part) | Durability | Debris | Rotary Torque |
| Comp. Ex. 1 | PET | yes | −0.077 | 0.083 | 0.16 | 5 | Δ | ∘ | observed |
| Comp. Ex. 2 | PET | yes | −0.071 | 0.049 | 0.12 | 5 | x | ∘ | observed |
| Ex. 1 | PET | yes | −0.048 | 0.072 | 0.12 | 5 | Δ | ∘ | slightly |
| | | | | | | | | | observed |
| Ex. 2 | PET | yes | −0.037 | 0.083 | 0.12 | 1 | ∘ | ∘ | slightly |
| | | | | | | | | | observed |
| Ex. 3 | PET | yes | −0.037 | 0.083 | 0.12 | 5 | ∘ | ∘ | slightly |
| | | | | | | | | | observed |
| Ex. 4 | PET | yes | −0.037 | 0.083 | 0.12 | 10 | ∘ | ∘ | slightly |
| | | | | | | | | | observed |
| Comp. Ex. 3 | PET | yes | −0.037 | 0.083 | 0.12 | 0.5 | x | ∘ | observed |
| Comp. Ex. 4 | PET | yes | −0.037 | 0.083 | 0.12 | 12 | ∘ | x | not observed |
| Ex. 5 | PET | yes | −0.031 | 0.049 | 0.08 | 5 | Δ | ∘ | slightly observe |
| Ex. 6 | PET | yes | −0.009 | 0.151 | 0.16 | 5 | ∘ | ∘ | slightly observe |
| Ex. 7 | PET | yes | 0.003 | 0.083 | 0.08 | 5 | ∘ | ∘ | not observed |
| Comp. Ex. 5 | PET | yes | 0.031 | 0.151 | 0.12 | 0.5 | x | ∘ | observed |
| Ex. 8 | PET | yes | 0.031 | 0.151 | 0.12 | 1 | ∘ | ∘ | slightly observe |
| Ex. 9 | PET | yes | 0.031 | 0.151 | 0.12 | 5 | ∘ | ∘ | observed |
| Ex. 10 | PET | yes | 0.031 | 0.151 | 0.12 | 10 | ∘ | ∘ | not observed |
| Comp. Ex. 6 | PET | yes | 0.031 | 0.151 | 0.12 | 12 | ∘ | x | not observed |
| Ex. 11 | PET | yes | 0.071 | 0.151 | 0.08 | 5 | ∘ | ∘ | not observed |
| EX. 12 | PET | yes | 0.080 | 0.240 | 0.16 | 5 | ∘ | ∘ | not observed |
| Comp. Ex. 7 | PET | yes | 0.095 | 0.215 | 0.12 | 0.5 | x | ∘ | slightly observe |
| Ex. 13 | PET | yes | 0.095 | 0.215 | 0.12 | 1 | ∘ | ∘ | not observed |
| Ex. 14 | PET | yes | 0.095 | 0.215 | 0.12 | 5 | ∘ | ∘ | not observed |
| Ex. 15 | PET | yes | 0.095 | 0.215 | 0.12 | 10 | ∘ | ∘ | not observed |
| Comp. Ex. 8 | PET | yes | 0.095 | 0.215 | 0.12 | 12 | ∘ | x | not observed |
| Comp. Ex. 9 | PET | yes | 0.108 | 0.268 | 0.16 | 5 | ∘ | x | not observed |
| Comp. Ex. 10 | PET | yes | 0.120 | 0.240 | 0.12 | 5 | ∘ | x | not observed |
| Comp. Ex. 11 | PET | yes | 0.160 | 0.240 | 0.08 | 5 | ∘ | x | not observed |
| Comp. Ex. 12 | PET | no | 0.031 | 0.151 | 0.12 | 5 | x | ∘ | slightly observ |
| Comp. Ex. 13 | Rayon | no | 0.031 | 0.151 | 0.12 | 5 | ∘ | x | not observed |
| Comp. Ex. 14 | Nylon | no | 0.031 | 0.151 | 0.12 | 5 | ∘ | x | not observed |

The magnetic layer of the magnetic disk 4 is formed by coating of a magnetic coating solution composed of the following compositions. The magnetic coating solution was prepared as described below. It should be noted that the words “part” and “parts” as used herein represent “part by weight” and “parts by weight”.

First, each composition listed in the following was blended in a kneader, and a predetermined amount of diamond particles having an average particle size shown in Table 1 are added therein and dispersed with a sandmill. After that, 3 parts of isocyanate and 40 parts of cyclohexanone were added in this order to the dispersed liquid so obtained. The resulting magnetic coating solutions were adjusted by filtering through a filter having an average pore diameter of 1 μm.

### Magnetic Coating Solution

| | | |
|---|---|---|
| Hexagonal barium ferrite | 100 | parts |
| Hexagonal ferrite employed here has a particle size | | |
| of 30 nm (average tabular diameter); average tabular | | |
| ration of 3.0; coercivity of 2400 Oe (192 kA/m); | | |
| saturation magnetization σs of 52 A m²/kg; specific | | |
| surface area of 70 m²/g (measured by the BET | | |
| method); and a molar ratios to Ba of 9.10 (Fe), 0.22 | | |
| (Co), and 0.71 (Zn). | | |
| Polyurethane Resin | 10 | parts |
| Carbon Black | 1 | part |
| (#50 manufactured by Asahi Carbon Co., Ltd.) | | |
| Isocetyl Stearate | 5 | parts |
| Butyl stearate | 1 | Part |
| Oleic acid | 1 | part |
| Stearic acid | 1 | part |
| Methyl ethyl ketone | 125 | parts |
| Cyclohexanone | 125 | parts |

A base layer on which the magnetic layer is layered is formed by coating of a nonmagnetic coating solution composed of the following compositions. The nonmagnetic coating solution was prepared as described below.

First, each composition listed in the following was blended in a kneader, and subjected to dispersion by use of a sandmill. After that, 6 parts of polyisocyanate and 40 parts of cyclohexanone were added in this order to the dispersed liquid so obtained. The resulting nonmagnetic coating solutions were adjusted by filtering through a filter having an average pore diameter of 1 μm.

### Nonmagnetic Coating Solution

| | | |
|---|---|---|
| α-Fe₂O₃ hematite | 100 | parts |
| α-Fe₂O₃ hematite employed here has an average long | | |
| axis length of 0.08 μm; specific surface area of 60 | | |
| m²/g (measured by the BET method); and a pH value of | | |
| 9. α-Fe₂O₃ hematite has been coated, with Al₂O₃ of 8 | | |
| by weight based on α-Fe₂O₃hematite. | | |
| Carbon Black | 25 | parts |
| having average particle diameter of 20 nm | 25 | parts |
| (CONDUCTEX SC-U manufactured by Columbia | | |
| Carbon Co., Ltd.) | | |
| Vinyl Chloride Copolymer | 15 | parts |
| (MR104 manufactured by Japan Zeon Co., Ltd) | | |
| Polyurethane Resin | 12 | parts |
| (UR8200 manufactured by Toyobo Co., Ltd.) | | |
| Oleic acid | 2 | parts |
| Stearic acid | 2 | parts |
| Phenyl Phosphonate | 5 | parts |
| Isocetyl Stearate | 4 | parts |
| Butyl stearate | 2 | Parts |
| Methyl ethyl ketone | 200 | parts |
| Cyclohexane | 50 | parts |

The nonmagnetic coating solution obtained as described above was coated on a polyethylene terephthalate substrate of 62 μm in thickness and 1.8 nm in center line average height, such that a thickness thereof after drying becomes 1.2 μm. Immediately after drying, the obtained magnetic layer coating solution was applied on the nonmagnetic layer by the blade coating technique such that the resultant magnetic layer has a thickness shown in Table 1. After drying, the magnetic disk was treated at a temperature of 90° C. and a line pressure of 300 kg/cm with a 7-roll calender. The magnetic medium was stamped out so as to have a disc shape having a diameter of 1.8 inch, and the disk was further heat-treated in a thermostat at 55° C. to facilitate curing of the thus coated layer. Thus, samples of various types of magnetic disks listed as Examples 1 to 15 and Comparative Examples 1 to 14 were produced.

More specifically, samples for Examples 1 to 15 and Comparative Examples 1 to 12 listed in Table 1 use a liner 6 made of polyethylene terephthalate (PET) and having fibers whose diameter varies in its length direction as described above; samples for Comparative Example 13 use a liner 6 made of Rayon and having fibers whose diameter does not vary in its length direction; and samples for Comparative Example 14 use a liner 6 made of Nylon and having fibers whose diameter does not vary in its length direction. Further, each liner has a thickness of 100 μm.

In the following, a description will be given on how to evaluate the running durability, production of liner debris, and rotary torque shown in Table 1.

Evaluation on the running durability is carried out by disposing within a commercially available Zip250 cartridge a magnetic disk 4 provided under the conditions described in Table 1; attaching a liner satisfying the conditions described in Table 1 to the commercially available Zip250 cartridge; loading the cartridge having thereon the liner into a drive device, rotating the magnetic disk 4 for 480 hours; and then inspecting the magnetic disk 4 for checking flaws produced on the magnetic disk 4 after rotation. In Table 1, the magnetic disks not flawed are marked with a circle (∘); slightly flawed are marked with a triangle (Δ); and significantly flawed are marked with a cross {x}. The forgoing evaluations were all carried out under the atmosphere of 23° C. and 50% RH.

Evaluation on the presence of liner debris is carried out by disposing within a commercially available Zip250 cartridge a magnetic disk 4 provided under the conditions described in Table 1; attaching a liner satisfying the conditions described in Table 1 to the commercially available Zip250 cartridge; loading the cartridge having thereon the liner into a drive device, rotating the magnetic disk 4 for 480 hours with a head not being loaded; and then inspecting the magnetic disk 4 With the naked eye to check fibrous dusts scattered over the magnetic disk 4 after rotation. Based on the shape of the fibrous dust identified by using an SEM photograph and the fact that the components of the fibrous dust correspond to those of the liner, which is identified by using Microscopic FTIR spectroscopythe, it was verified that the fibrous dust was liner debris. In Table 1, the magnetic disks that produced little liner debris are marked with a circle (∘); a small amount of liner debris are marked with a triangle (Δ); and a great amount of liner debris are marked with a cross {x}. The forgoing evaluations were all carried out under the atmosphere of 23° C. and 50% RH.

Further, evaluations on the increase of rotary torque is carried out by attaching a liner 6 satisfying the conditions described in Table 1 onto a substrate 20; engaging a magnetic disk 4 with a rotary spindle 30 such that the magnetic disk 4 is spaced 300 μm from the substrate 20; fixing the magnetic disk 4 to the rotary spindle 30 with a pin 31; rotating the magnetic disk 4 at 3000 rpm for 1 minute in a 23° C. and 50% RH environment; and monitoring whether the load current of the rotary spindle 30 increases. The rotary spindle 30 employed here for the aforementioned measurement was Spin Stand LS-90 manufactured by Kyodo Denshi System Co., Ltd. Specifically, the substrate 20 and the liner 6 each have an outer diameter of 50 mm and an inner diameter of 11 mm, and the magnetic disk 4 has an outer diameter of 46.5 mm and an inner diameter of 5.4 nm.

In Table 1, Formula 2 obtained by inverting the aforementioned conditional formula (Formula 1)and given by:
−0.05≦a−b≦0.1 (Formula 2)
was used. More particularly, the foregoing evaluations on the magnetic disk cartridges were performed under various conditions obtained by varying the value of “a−b” from −0.0077 to 0.16 and varying the amount of diamond particles added from 0.5 parts to 12 parts, and the evaluation results are listed as Examples 1 to 15 and Comparative Examples 1 to 11. Besides, the evaluation result when a liner 6 material having fibers whose diameter do not vary in its length direction is used is shown as that of Comparative Example 12; and the evaluation results when a liner 6 material is other than polyethylene terephthalate (PET) are shown as those of Comparative Example 13 and 14.

It was found from the evaluation results on Examples 1 to 15 in Table 1 that so long as an average diamond particle size (a) and a magnetic layer thickness (b) of the diamond particles used are selected to satisfy Formula 2 and when a material of the liner 6 is selected from those composed of polyethylene terephthalate (PET) fibers whose diameters varies, a good dust-removal effect can be achieved by the liner 6 without any problems associated with the running durability, the liner debris, and the increase of the rotary torque. Though slight increase of the rotary torque and production of slight flaws were observed in some samples, they are within an acceptable level.

Further, it was found from the evaluation results on Comparative Examples 1 and 2 that when the value of (a−b) is smaller than −0.05 and does not satisfy Formula 2, the particle size of the diamond particles are too small with respect to the thickness of the magnetic layer, as a result of which the rotary torque increases, and the running durability deteriorates, which indicates presence of flaws produced by the liner 6 on the magnetic layer

Further, it was found from the evaluation results on Comparative Examples 3, 5 and 7 that when the amount of the diamond particles added is less than 1 part, even if the value of (a−b), satisfies the foregoing Formula 2, the rotary torque increases, and the running durability deteriorates, which indicates presence of flaws produced by the liner 6 on the magnetic layer. Further, it was found from the evaluation results on Comparative Examples 4, 6 and 8 that when the amount of the diamond particles added is more than 10 parts, even if the value of (a−b) satisfies the foregoing Formula 2, the amount of the diamond particles are too much and therefore a large amount of liner debris is produced.

Further, it was found from the evaluation results on Comparative Examples 9, 10 and 11 that when the value of (a−b) is larger than 0.1 and does not satisfy the foregoing Formula 2, the particle size of the diamond particles is too large with respect to the thickness of the magnetic layer and therefore a large amount of liner debris is produced.

Further, it was found from the evaluation results on Comparative Example 12 that when the liner 6 is formed of a material having fibers whose diameter does not vary, even if the value of (a−b) satisfies Formula 2 and the amount of the diamond particles added falls within the range of 1 to 10 parts, the running durability deteriorates, which indicates presence of flaws on the magnetic layer.

Further, it was found from the evaluation results on Comparative Examples 13 and 14 that when the liner 6 is formed of Rayon or Nylon instead of polyethylene tetephthalate (PET), even if the value of (a−b) satisfies Formula 2 and the amount of the diamond particles added falls within the range of 1 to 10 parts, a large amount of liner debris is produced.

What is claimed is:

1. A magnetic disk cartridge comprising:
a magnetic disk comprising a discoid nonmagnetic substrate and a magnetic layer that is formed of a ferromagnetic material and disposed on at least one surface of the nonmagnetic substrate, the magnetic disk having a surface recording density of at least 158.7 Mbit/cm²;
a casing which rotatably holds therein the magnetic disk;
a liner, which is composed of polyethylene terephthalate fibers and attached to a surface of the casing that faces the magnetic disk, for removing contaminants on the surface of the magnetic disk,
wherein the magnetic layer containing diamond particles at 1% to 10% by weight with respect to the ferromagnetic material, the diamond particles having an average particle size satisfying a formula given by:
b−0.05≦a≦+0.1
where “a” represents the average particle size of the diamond particles in units of μm and “b” represents a thickness of the magnetic layet in units of μm, and
wherein a fiber diameter of the fibers of the liner varies along a length direction of the fibers.

2. The magnetic disk cartridge as defined in claim 1, wherein a minimum fiber diameter of the fibers of the liner is within the range of 5% to 60% of a maximum fiber diameter of the fibers.

3. The magnetic disk cartridge as defined in claim 1, wherein the ferromagnetic material is ferromagnetic hexagonal ferrite powder.

4. The magnetic disk cartridge as defined in claim 2, wherein the ferromagnetic material is ferromagnetic hexagonal ferrite powder.

5. The magnetic disk cartridge as defined in claim 1, wherein the average particle size of the diamond particles is in the range of 0.01 to 2 μm.

6. The magnetic disk cartridge as defined in claim 1, wherein the surface recording density of the magnetic disk is at least 793.5 Mbit/cm².

7. The magnetic disk cartridge as defined in claim 1, wherein the magnetic disk has a track density of not less than 10 Ktpi.

8. The magnetic disk cartridge as defined in claim 1, wherein the magnetic disk has a track recording density of not less than 100 Kbpi.

9. The magnetic disk cartridge as defined in claim 1, wherein the magnetic disk further comprises a lower layer which is formed on the substrate and substantially nonmagnetic, and an upper layer constituting a magnetic layer which is formed on the lower layer.

10. The magnetic disk cartridge as defined in claim 1, wherein the substrate is flexible.

11. The magnetic disk cartridge as defined in claim 1, wherein the substrate has a thickness in the range of 2 to 100 μm.

12. The magnetic disk cartridge as defined in claim 1, wherein the substrate has a thickness in the range of 2 to 80 μm.

13. The magnetic disk cartridge at defined in claim 1, wherein the substrate is made of polyethylene terephthalate.

14. The magnetic disk cartridge as defined in claim 1, wherein the substrate is made of polyethylene naphthalate.

15. The magnetic disk cartridge as defined in claim 1, wherein the magnetic disk is designed so that data recorded thereon is reproduced by an MR head of a disk drive.

16. The magnetic disk cartridge as defined in claim 1, wherein the magnetic disk is designed so that data recorded thereon is reproduced by a GMR head of a disk drive.

17. The magnetic disk cartridge as defined in claim 1, wherein the magnetic disk is designed so that data recorded thereon is reproduced by a TMR head of a disk drive.
